(19) United States
(12) Patent Application Publication
(10) Pub. No.: US 2012/0174872 A1
(43) Pub. Date: Jul. 12, 2012

(54) DEVICE AND METHOD TO TREAT ANIMAL HOOVES

(75) Inventor: Randall Richards, Lockport, IL (US)

(73) Assignee: GEA FARM TECHNOLOGIES, INC., Naperville, IL (US)

(21) Appl. No.: 13/348,360

(22) Filed: Jan. 11, 2012

Related U.S. Application Data
(60) Provisional application No. 61/460,983, filed on Jan. 11, 2011.

(51) Int. Cl. A01K 29/00; A61D 11/00; A61D 99/00

(52) U.S. Cl. 119/665

(57) ABSTRACT

A sprayer device and method to treat animal hooves by spraying concentrated foot treatment fluid directly onto the hooves. Substantially all overspray of the hoof treatment fluid is collected and recycled thereby minimizing loss of fluid.

This application claims priority to U.S. Provisional Application No. 61/460,983, filed Jan. 11, 2011, which is incorporated herein by reference in its entirety.

The invention relates generally to hoof treating apparatus and methods, and more particularly to a hoof spray device that captures overspray of hoof treatment fluid.

### BACKGROUND OF THE INVENTION

Within the last 25 years, the dairy industry has experienced a dramatic increase in hoof related disease and morbidity, particularly in dairy cows. One reason for this is likely due to the fact that more and more dairy cows are being maintained on hard surfaces such as concrete during their milking and non-milking times. Another possible reason is that larger dairy herds transmit contagious disease more easily from one cow to the next. A third reason is possibly that cows are sold and transferred from farm to farm more frequently and thereby spread disease. Hoof disease can cause a dairy cow considerable pain and thereby reduces the amount of milk that the cow will produce.

Approaches to treat hoof disease have been developed. One approach to treating animal hooves is to topically treat each affected hoof with a chemical manually. The chemical is typically sprayed on the hoof manually by a farm worker when the animal is brought in for milking. While a topical treatment is effective it is expensive due to the labor involved and is not often used for that reason on larger farms.

A second approach that is used is to guide the animals through a footbath containing a chemical diluted in water that treats the hooves. This approach has the disadvantage that the chemical is usually highly diluted with water in the footbath. Additionally, the footbath must be frequently emptied and refilled with fresh chemical because the footbath gets rapidly soiled and losses effectiveness. Typically, approximately 80% of the chemical that is placed into the footbath is discarded after 200-300 cows have passed through the footbath. That means that up to 80% of the chemicals that are used are wasted.

Currently two of the most prevalent chemicals used for hoof care are formaldehyde and copper sulfate. These chemicals are used because of their relative effectiveness in a diluted form. Formaldehyde is problematic in the use on a dairy because of negative potential human exposure issues. Copper sulfate is problematic because it can accumulate in the soils when the footbath is emptied into the manure lagoon and is then placed onto agricultural fields when the manure products are applied as fertilizers. Because of these problems with traditional footbaths other hoof treatment systems have been devised.

Hoof treatment systems have been described that use spray systems to treat the hoof. One such device is described in U.S. Pat. No. 5,630,379, and includes a spray bath that uses an electronic control to activate the sprayers to wash the hooves and then to apply a chemical to the hooves to promote hoof health. A major disadvantage to this sprayer system is that the chemical is not directed to the hoof exclusively and a large amount of chemicals are wasted through overspray.

One hoof treatment system has been described and manufactured by VINK-ELST BV (Netherlands) wherein the cow climbs onto a split platform and the rear of the hoof is sprayed by a chemical. The chemical is then collected in trays through which the cow walks, is filtered, and then recycled to minimize loss. This system has two major disadvantages. First the cows are required to walk slowly through the trays. This slows the cows' exit from the milking parlor where most hoof baths are placed, and more importantly the trays are soiled by the animals causing an inactivation of the chemical and requiring frequent replacement of the chemical and therefore wasted chemical.

Another hoof treatment system has been described in U.S. Patent applications 2008/0120089 and 2009/0178626. This device sprays the hoof of the animal when it steps onto a pressure sensitive mat. While the device reduces waste of the chemical by use of the directed and specific spray, the device has the disadvantage that the pressure mat is expensive and subject to failure due to constant use. Additionally, every individual spray head requires an activation and deactivation capability making it an expensive overall device to manufacture and maintain.

The present invention overcomes the shortcomings of the previously described devices and systems, by recycling and filtering hoof treatment chemicals in an economic design. Additionally the present invention has a low maintenance requirement.

### SUMMARY OF THE INVENTION

The present invention is directed to a device for applying a hoof treatment fluid to animal hooves. The device includes a storage reservoir to store a hoof treatment fluid, a sensor to detect the presence of an animal, and preferably to detect a position of at least one of its hooves, a hoof treatment fluid sprayer directed at an animal hoof position, a recycle compartment positioned to collect a substantial portion of the hoof treatment fluid that does not strike the hooves, and a return system to return the collected portion of the hoof treatment fluid to the storage reservoir. An automated control device can be used to process sensor signals and control pumps, valves, and other system components. This hoof treatment device is placed in a pathway for an animal such that the animal can pass across it when it walks.

In a system of the present invention, there is a hoof sprayer and a recycling portion. The sprayer can include multiple spray nozzles that spray a foot treatment solution from a reservoir directly onto an animal's foot or hoof. Some of the sprayed fluid does not strike the hoof, so the overspray is collected in a collection tray. The overspray is directed above the animal walking surface so that the collected overspray is relatively clean.

After the overspray is collected, it is filtered and pumped back into the storage reservoir. This system uses a minimal amount of hoof treatment fluid because the overspray recycling system reduces waste. Contamination of the recycled fluid is very low because the fluid is sprayed above, and not on, the floor. Thus, some of the spray contacts a hoof, but most of the rest of the spray is captured before it is contaminated by the floor. Because very little hoof treatment fluid is needed on a per cow basis, the system is very cost effective. A method for treating animal hooves is also disclosed, and includes the steps of detecting an animal, spraying a treatment fluid toward the animal's hooves, and collecting oversprayed treatment fluid in a recycling system.

### BRIEF DESCRIPTION OF THE DRAWINGS

FIG. 1 is a schematic overhead view of the present invention at rest where spraying occurs along the line of travel of the animal;

FIG. 2 is a schematic overhead view of the present invention when activated by an animal where spraying occurs along the line of travel of the animal;

FIG. 3 is a schematic and cross-sectional side view of the present invention where spraying occurs along the line of travel of the animal;

FIG. 4 is a schematic overhead view of the present invention during a wash event where spraying occurs along the line of travel of the animal;

FIG. 5 is a schematic overhead view of the present invention at rest where spraying occurs perpendicular to the line of travel of the animal; and

FIG. 6 is a schematic side view of the present invention at rest where spraying occurs perpendicular to the line of travel of the animal.

### DETAILED DESCRIPTION OF THE INVENTION

The present invention is directed to apparatus and methods for applying a hoof treatment fluid to animal hooves. A suitable device in accordance with the present invention includes; a storage reservoir to store a hoof treatment fluid, a sensor to detect the presence of an animal by detecting hooves, other body parts or an identification device on the animal, a hoof treatment fluid sprayer directed toward a hoof location and toward a recycle compartment that is preferably positioned opposite to the sprayer for collecting a substantial portion of the hoof treatment fluid that does not strike the hoof, a return system for returning the hoof treatment fluid to the storage reservoir, and an optional automated controller to interact with the sensor and the sprayer. The automated controller 17 is optional because the sprayer and related components can be activated directly by the sensor.

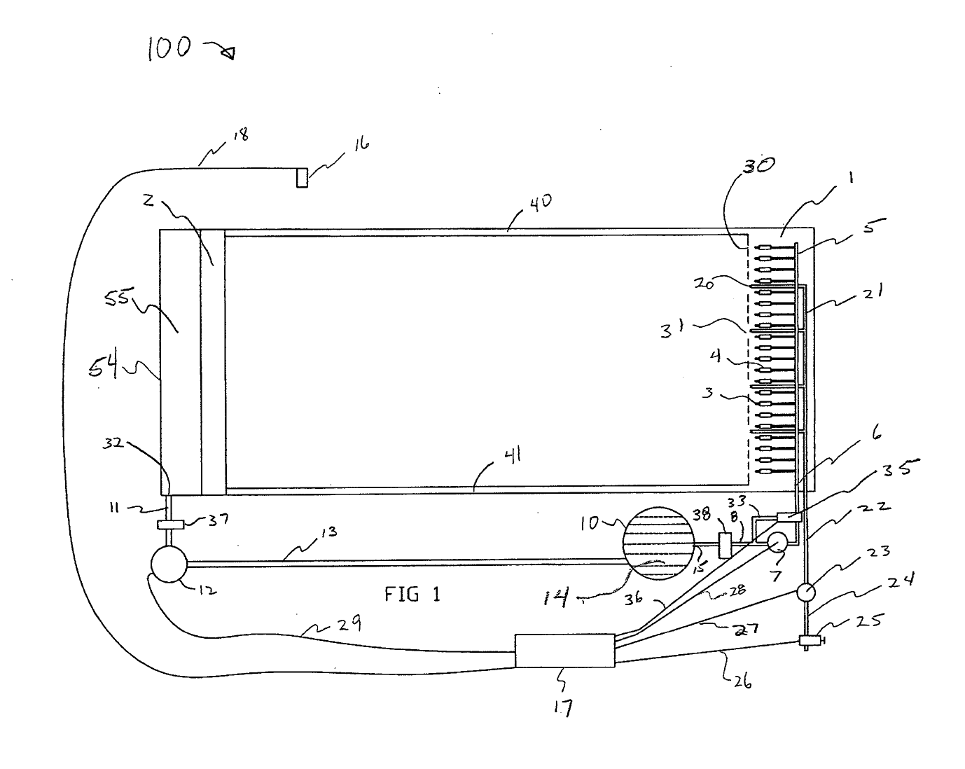

This device is placed in a pathway for an animal such that the animal can pass across it when it walks. In one embodiment, the device is placed in the exit lane of a milking parlor to spray hooves after the animal has been milked and is leaving the milking parlor. A “hoof” or hooves as defined herein can include any portion of an animal foot, or lower leg area, including the foot, the horny sheath covering the toes of a mammal, and the tissue adjacent to the horny sheath. FIG. 1 depicts one embodiment of the present invention in an overhead view wherein sprayer device 100 is shown before an animal enters. In this embodiment, a sprayer compartment 1 and a recycle compartment 2 are connected by sides 40 and 41. In another embodiment, the sprayer compartment 1 and the recycle compartment 2 are not connected, but are attached to the floor or supporting platform. The sprayer compartment 1 is preferably positioned opposite the recycle compartment 2 such that a substantial amount of overspray that does not contact the hoof enters the recycle compartment. The sprayer compartment 1 preferably contains spray nozzles 3, but other types of sprayers can be used in the invention. The spray nozzles 3 are connected to positive shutoff valves 4 in the illustrated embodiment. One positive shutoff valve 4 may be located adjacent to every spray nozzle 3 or one positive shutoff valve 4 may be used for multiple spray nozzles. In the preferred embodiment, each spray nozzle 3 is connected a positive shutoff valve 4. One such spray nozzle 3 and positive shutoff valve 4 combination is Nozzle body model QJ17560A-1-NYB manufactured by TeeJet located at 1801 Business Park Drive, Springfield, Ill., 62703 USA.

A manifold 5 is configured to supply hoof treatment fluid to the spray nozzles 3 equally. The manifold 5 is preferably connected to a pump 7 through a conduit 6. The pump 7 is connected to a reservoir 10 through a conduit 8. A filter 38 resides within the conduit 8 to filter particulates out of the hoof treatment fluid that passes through pump 7. The filter 38 is a feature that can be used when the possibility of the presence of particulates may be pumped to nozzles 3 causing a restriction or plugging of the nozzles.

The sprayer compartment 1 also preferably includes flush nozzles 20. The flush nozzles 20 are an optional feature present in the device depicted in FIG. 1 to provide a flushing of waste from the area in front of sprayer compartment 1, thereby keeping that area free from manure and debris that might interfere with the function of the spray nozzles 3 or otherwise contribute to contamination of the animal hooves. The flush nozzles 20 are connected to a manifold 21, which is connected to a pump 23 through a conduit 22. The pump 23 is connected to a valve 25 through a conduit 24. The valve 25 may be opened or closed by a controller 17 either through an electrical connection 26 or wirelessly. Alternatively, the valve 25 may be operated on a timed basis independent of the controller 17. A water supply can be connected directly to the valve 25. Alternatively, a chemical solution may be provided to the valve 25 under pressure. The flush nozzles 20 provide enough fluid to clean an area between the sprayer compartment 1 and the recycle compartment 2, so that the sprayer function of the spray nozzles 3 remains unimpeded by debris accumulating between the compartments 1 and 2.

In an alternative configuration (not shown), the present invention has the flush nozzles contained within a center sheathed area. The center sheathed area is positioned between the compartments 1 and 2 to allow the wash fluid to be sprayed essentially perpendicular to the direction of movement of the animal through the device. The center sheathed area traverses between the sprayer compartment 1 and the recycle compartment 2 and a central conduit provides the wash fluid to the flush nozzles that then clean the area.

The recycle compartment 2 preferably contains a collection tray 55 connected to the recycle pump 12 through the conduit 11. The conduit 11 opens into recycle compartment 2 through an opening 32. The conduit 13 connects the recycle pump 12 to the reservoir 10. A filter 37 is disposed within conduit 11. The filter 37 may be one or multiple filtration devices that can remove debris that may have incidentally passed through the collection tray 55.

The sensor 16 senses the presence of an animal by detecting the animal itself of an ear tag or other such device. Preferably, the sensor 16 senses a hoof and its position and transmits a signal that activates the device. Nonetheless, by simply detecting the presence of an animal, it can be predetermined when and where to spray treatment fluid, so it is not necessary to sense individual hooves.

There may be more than one sensor incorporated into the device that can cause the spray nozzles 3 to spray hoof treatment fluid at different times as the animal moves between sprayer compartment 1 and recycle compartment 2 (Right to left, as illustrated.). In one embodiment, two sensors 16 are used to activate the device to spray the front hooves and the spray the rear hooves at two different times based on the position of the animal as detected by the two sensors 16. In the embodiment shown in FIG. 1, only one sensor 16 is needed because either the sensor 16 is positioned relatively high and the distance between the sprayer compartment 1 and the recycle compartment 2 are sufficiently far apart that all of the animal's hooves are between the two compartments 1 and 2 when the sensor 16 is activated or the sensor 16 is positioned low such that each set of animal legs can be detected to activate the system. Other sensor 16 positions are possible.

The sensor 16 detects the presence of an animal that has entered the device 100 and sends a signal to the controller 17 (when included) through an electronic connection 18 or through a wireless transmitter (not shown). After receiving the signal from the sensor 16, the controller 17 activates the pump 7 through electrical connection 28 or a wireless connection which pumps hoof treatment fluid 14 through the conduit 6, the manifold 5, the shutoffs valves 4 and the spray nozzles 3. In an alternate embodiment when a controller 17 is not used, the sensor 16 directly activates the pump 7 to begin spraying the hooves. As the hoof treatment fluid exits the spray nozzles 3, it passes through the opening 30 in the sprayer compartment 1 and the hoof treatment fluid that does not spray the hooves travels to the recycle compartment 2 to be recycled.

The sensor 16 may use one or more types of sensing technology to identify the presence of an animal within the sprayer device 100. The sensor 16 can be a photoelectric sensing system that is activated when the animal breaks a beam of light between an emitter and a detector of the sensor. A typical sensor that might be used is Model DPPS made by Greenfield Industries, Inc. located at 2501 Davis Creek Rd., Seneca, Calif. 29678. The sensor 16 may use an infrared light detector. The sensor 16 may be a motion detector that uses passive infrared, ultrasonic or microwave technology or a combination thereof. An example of an ultrasonic sensor that can be used in the present invention is Parallax's PING device distributed by Trossen Robotics located at 2739 Curtiss Lane, Downers Grove, Ill. 60515. The sensor 16 may be a proximity sensor based on capacitance. The second sensor (not shown) that may be installed at a second location to turn on the device a second time, may be the same type or different type as the first sensor. The sensor 16 may be a physical sensor. One type of physical sensor is a wand type sensor that has a magnetic switch that is tripped when an animal bends or pivots the wand. Other sensors may also be used if they can identify the presence of the animal or its individual hooves. The sensor 16 may be positioned above or to the side of the animal depending on the nature of the sensor 16 or other physical features of the dairy. Optionally, the sensor 16 does not detect the animal itself, but identifies an ear tag or some other identification device on the animal.

In the embodiment depicted in FIG. 1, the solenoid valve 35 is located between the manifold 5 and the pump 7 within the conduit 6. When the sensor 16 detects an animal, the sensor 16 or the optional controller 17 activates the pump 7, and can also cause the solenoid valve 35 to close through the electrical connection 36 or a wireless means. When the solenoid valve 35 is closed, hoof treatment fluid cannot pass between the manifold 5 and the conduit 8 through the conduit 33. When the solenoid valve 35 is closed and the pump 7 is activated, the hoof treatment fluid is pressurized and sprays through spray nozzles 3 at a sufficient force to allow substantially all of the hoof treatment fluid to reach the recycle compartment 2 when the path is unimpeded by the presence of an animal. The solenoid valve 35 is in the open position when the device is not spraying hoof treatment fluid. When the solenoid valve 35 is in the open position, which is the default and de-energized state, the hoof treatment fluid can pass directly between the manifold 5 and the conduit 8 through the conduit 33. In this state, pressure is released from the conduit 6 and the manifold 5 resulting in little or no pressure remaining in the conduit 6 or the manifold 5.

When the shutoff valves 4 experience reduced pressure, they stop fluid flow out of spray nozzles 3 when reaching their preset pressure release value. This value is typically between 1-40 psi above ambient. In a preferred embodiment, this value is between 3-15 psi above ambient. For example, if the preset value for the shutoff valves 4 is 8 psi above ambient, then when the solenoid valve 35 opens and the pump 7 stops pumping the pressure drops below 8 psi above ambient rapidly and the shutoff valves 4 stop the hoof treatment fluid spray abruptly. In this scenario, the fluid stream travelling between the sprayer compartment 1 and the recycle compartment 2 stops abruptly, preventing a dribbling of fluid into the space between the two compartments as the pressure gradually dissipates. This reduces waste of the dribbling hoof treatment fluid, making the device very efficient through the conservation of chemicals used in the device. This conservation also has the advantage of making the device very economical to use.

The controller 17 or the sensor 16 may control the length of time that the pump 7 runs thereby limiting the amount of hoof treatment fluid sprayed at any one time. For example, when the sensor 16 detects an animal, it may turn on the pump 7 for three seconds and then turn the pump 7 off. This will conserve spray that might strike the hoof that is not needed since the hoof is sufficiently covered in hoof treatment fluid within the three second time period. Alternatively, the controller 17 may turn the pump off.

At occasional times, the floor area between compartments 1 and 2 and sides 40 and 41 may become soiled by an animal. The sides 40 and 41 may be elevated to allow and control the passage of flush fluids and debris. A plain water or chemical solution wash can be used to remove the soil. The system can include the wash nozzles 20, the wash manifold 21, the conduit 22, the pump 23, the conduit 24, and the valve 25 to produce the desired washing. At a chosen interval, fresh water may be pumped onto the floor area to wash away any soiling that may occur. This interval may be controlled by the controller 17 based on a lull of activity or it may be determined by a set schedule. Alternately, a separate timer can be used to turn on the wash system. The valve 25 is connected to a water source and can be opened by a timer or the controller 17 through the electrical connection 26 or a wireless connection. The conduit 24 connects the valve 25 to the pump 23 which can be activated at the same time that the valve 25 opens through the electrical connection 27 or a wireless connection. When activated, the pump 23 forces water through the conduit 22 and wash manifold 21, and through the nozzles 20 washing away any soil in the floor area. If the water pressure at the available source is about 30 psi or higher, a pump may not be needed to wash the floor.

The size of the hoof treatment chemical reservoir 10 can vary depending on the type of hoof treatment fluid that is used and the number of animals treated. In one embodiment, the reservoir 10 contains at least approximately one month's worth of ready to use hoof treatment fluid. This allows for a minimal replacement routine. In a second embodiment, a concentrate vessel contains a concentrated hoof treatment fluid that is diluted using locally obtained water prior to going into the reservoir 10. This can be accomplished using a venturi type or other suitable mixer. This can also be accomplished using multiple pumps and valves to control the mixing of a solution.

The recycle compartment 2 preferably contains collection tray 55 into which hoof treatment fluid accumulates after striking the rear wall 54 of the collection tray 55. The opening 32 connects to the conduit 11 wherein the recycled hoof treatment fluid is filtered through the filter 37. Hoof treatment fluid is returned to the reservoir 10 through conduit 13 by the recycle pump 12 which can be controlled through the controller 17, for example, via an electrical connection 29 or a wireless connection. The pump 1 may be activated by the sensor 16 or the controller 17. Recycled hoof treatment fluid can then be resupplied to the spray nozzles 3, as described above.

In one embodiment, two separate hoof treatment chemical fluid streams are combined just prior to filling a relatively small reservoir 10. Water may or may not be added to this mixed stream to produce the final hoof treatment fluid. Because a small reservoir is used, when the cycle of animals passing through the device 100 is complete, very little hoof treatment fluid remains in the reservoir 10. This is particularly beneficial when a somewhat labile active ingredient is used as the hoof treatment fluid. For example, when a hoof treatment fluid containing chlorine dioxide is made using this scheme, the remaining hoof treatment fluid may only be stable for a limited timeframe. By making the hoof treatment fluid in situ, as described above and keeping the reservoir small, the fluid is still highly active and efficacious when used. This mixing can be controlled by the controller 17 or a separate control system.

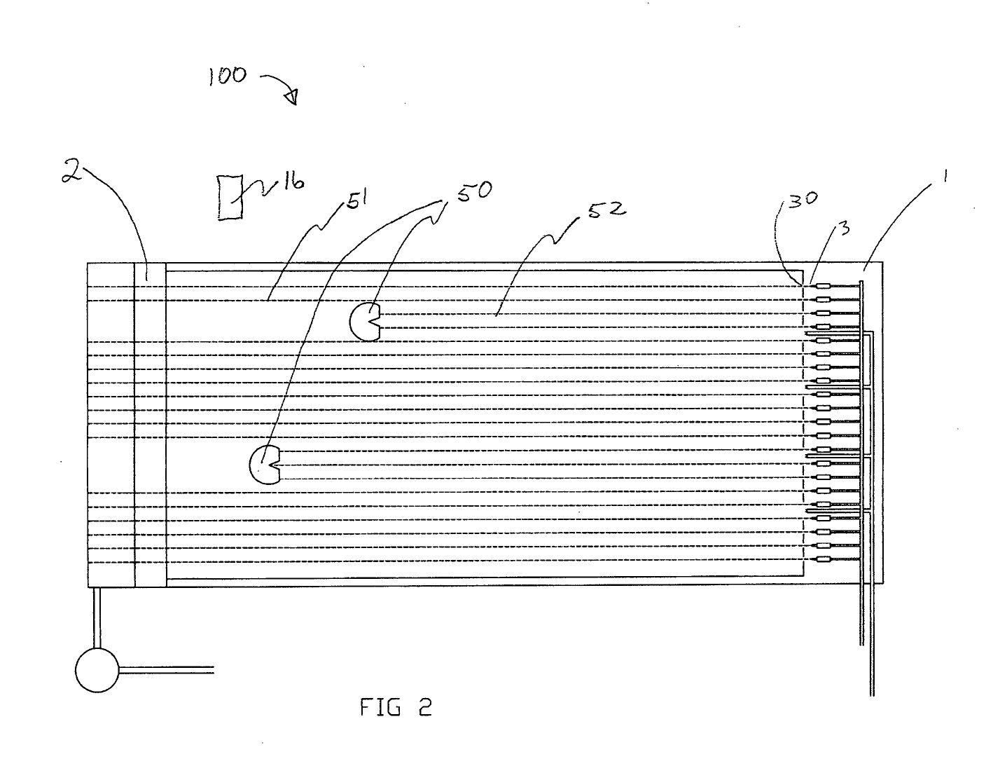

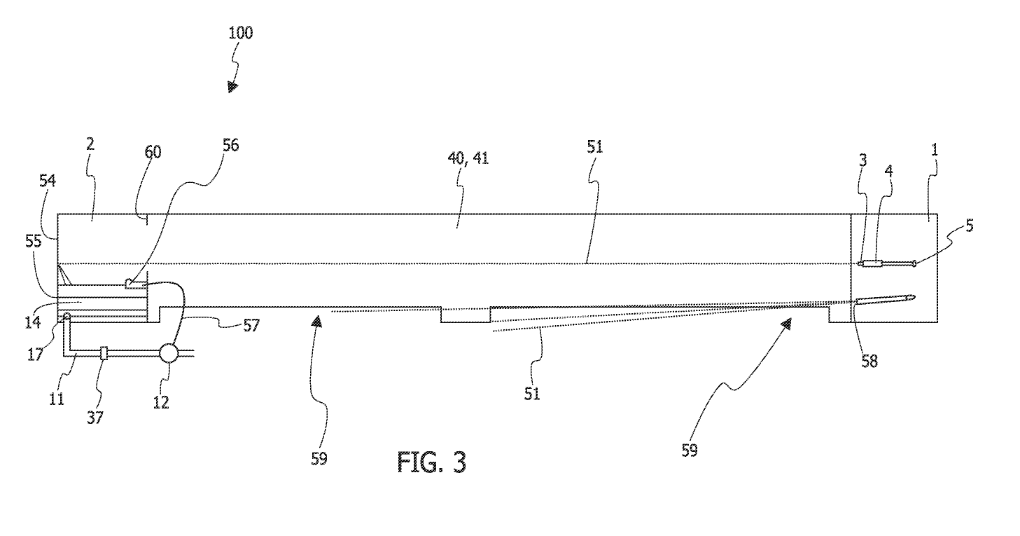

FIG. 2 shows the device 100 in an overhead view after activation by an animal. Both front hooves 50 are located at a position aligned with the sprayer device 100. When the presence of an animal is detected by the sensor 16, hoof treatment fluid begins to spray from sprayer compartment 1 out of the spray nozzles 3 and through the openings 30. A hoof treatment fluid stream 51 sprays above the floor between the sprayer compartment 1 and the recycle compartment 2 when unobstructed. In one embodiment, this stream of fluid maintains a tight diameter and is referred to as a narrow solid stream. When the animal hoof 50 is present in the device 100 the hoof treatment fluid stream 52 strikes the hoof 50, at least partially covering the hoof with hoof treatment fluid or unobstructed streams 51 enter recycle compartment 2 and are collected to be recycled to the reservoir 10. The unobstructed streams are illustrated in FIG. 3 as straight lines, but it is understood that an appropriate arc shape will result from spray passing from one side to the other.

FIG. 3 shows the device 100 from a side view after the device 100 has been activated. The manifold 5 delivers hoof treatment fluid through the positive shutoff valves 4 and through the spray nozzles 3. The hoof treatment fluid stream 51 sprays directly across the device 100 and strikes the rear wall 54 of the recycle compartment 2 and is collected in collection tray 55. The spray nozzles 3 are preferably positioned so that a maximum amount of fluid stream 51 is collected within the recycle compartment 2. A sensor float 56 preferably resides within the collection tray 55. When the collection tray 55 collects a sufficient amount of hoof treatment fluid, the sensor float 56 activates the recycle pump 12 through an electrical connection 57 in one embodiment returning the sprayed hoof treatment fluid that did not strike the animal hoof 50 back to the reservoir 10 for reuse. Alternatively, the sensor 56 can activate the controller 17 which then activates the pump 12. Once activated, the pump 12 pulls hoof treatment fluid through the opening 17, the conduit 11, and the filter 37. In an alternative embodiment of the present invention, the float sensor 56 is not needed since the pump 12 is activated by the controller 17.

One advantage of the present invention is that a more concentrated hoof solution can be put on the animal hoof. This is more efficient because there is less wasted chemical compared to a traditional footbath.

Preferably, a guard 60 covers the recycle compartment 2 so that little or no soiling can occur when the animal passes over the recycle compartment 2. This minimizes the recycled hoof treatment fluid from being contaminated and deactivated by manure or other soil. The filter 37 also serves to ensure that less particulate material returns to the reservoir 10.

As described above, the wash nozzles 58 spray wash fluid onto the floor area between sprayer compartment 1 and recycle compartment 2 and between sides 40 and 41 to remove any accumulated or deposited soil in the floor area. As shown in FIG. 3, the spray is preferably directed downward to force soil out from between the compartments and sides. This spray is preferably strong enough to remove the soil, but not so strong as to spray the soil into recycle compartment 2, thereby contaminating the hoof treatment fluid. The number of spray nozzles 3 can be sized and spaced appropriately so that the entire floor area is sprayed and cleaned effectively. In one embodiment the sides 40 and 41 can allow the sprayed wash fluid to pass under the sides through the open space 59. The recycle compartment 2 can also have open spaces under the compartment that allow for fluid drainage. The wash fluid can be water or a wash solution. In one embodiment, a water stream is injected with surfactants to reduce the water surface tension thereby allowing more efficient washing.

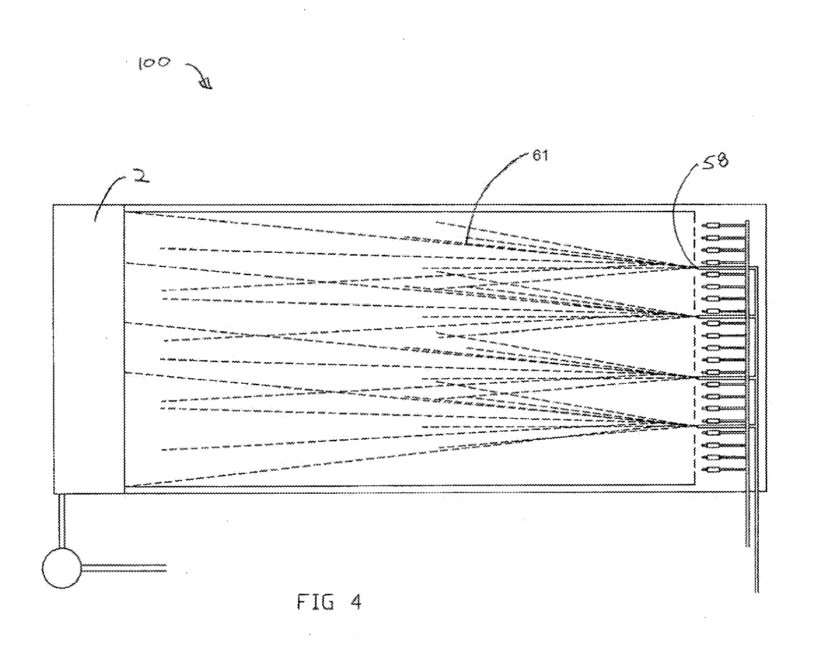

FIG. 4 shows an overhead view of the present invention that shows the spray pattern of the wash fluid 60. The wash nozzles 58 are designed to produce a more fan type spray so as to cover the entire area between elevated compartments 1 and 2. The spray wash fluid can pass under the sides and the recycle compartment 2 and can carry any soil under these with the spray wash fluid.

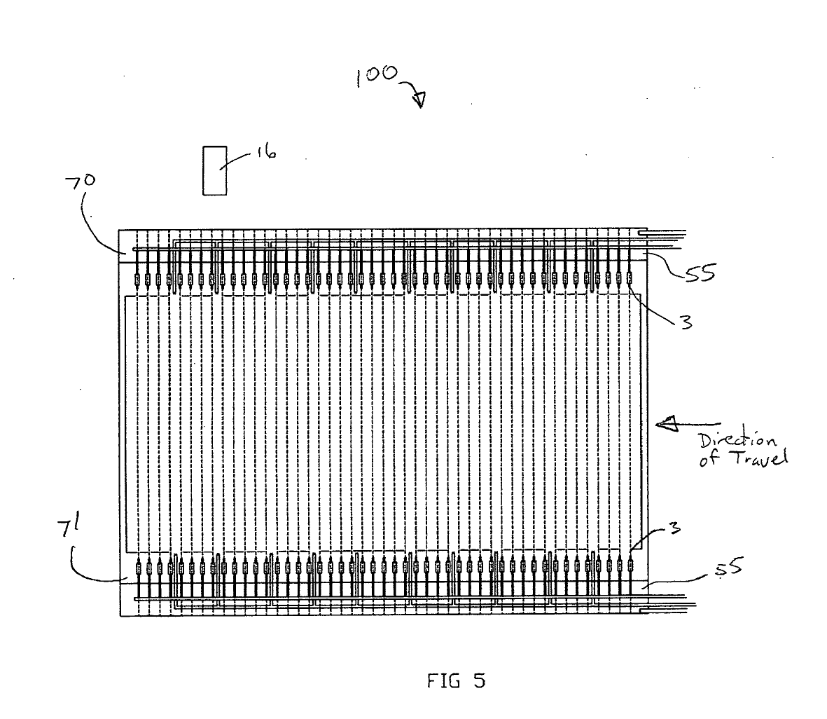

FIG. 5 shows an overhead view of another embodiment of the present invention, in which the hoof treatment fluid is sprayed perpendicular to the animal's path. Sprayer compartments 70 and 71 both contain hoof treatment fluid spray nozzles 3 and hoof treatment fluid recycle areas 55 within the sprayer compartments. Hoof treatment fluid is preferably sprayed from both compartments. In one embodiment, the spray patterns from one side are arranged such that they do not intersect the spray patterns from the opposite side. This can be accomplished by setting the spray pattern on one side slightly higher than the spray pattern from the opposite side. Alternatively, the spray nozzles 3 may be staggered horizontally such that the spray streams from side one travel between the spray streams from the opposite side and do not interfere with each other. In another embodiment, the spray nozzles 3 on each side operate at slightly different times so that they do not interfere with each other. For example, one side sprays and then stops, and then the second side sprays and then stops at alternate periods. In each case, the hoof treatment fluid from both spray streams are substantially captured within the opposite sprayer compartment. From each sprayer compartment 70 and 71, the hoof treatment fluid is recycled as is described in FIG. 1.

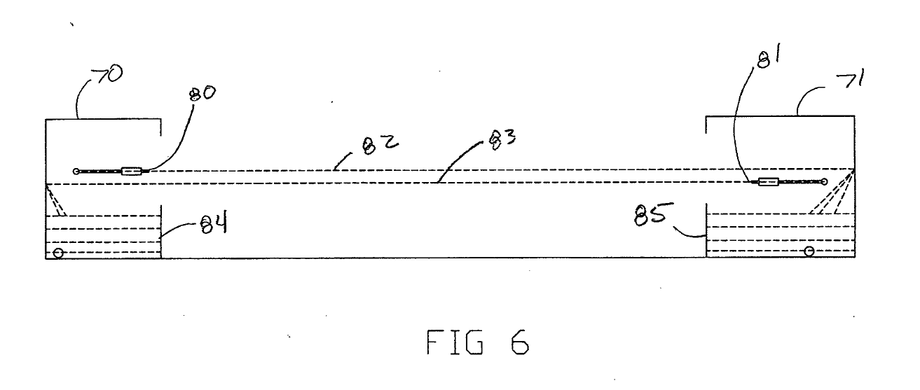

FIG. 6 shows a side view of the same embodiment as described FIG. 5. The sprayer compartments 70 and 71 contain hoof treatment fluid sprayer nozzles 80 and 81. The sprayer nozzles 80 and 81 are vertically offset so that spray streams 82 and 83 do not interfere with each other and permit the hoof treatment fluid that does not strike the animal hoof to be collected in the recycle areas 84 and 85. The hoof treatment fluid can then be recycled back to the reservoir for re-spraying as described above.

The present invention is designed to introduce a hoof treatment fluid onto the hoof in a very efficient manner that wastes very little hoof treatment chemicals. As a consequence, the hoof treatment fluid can be more concentrated and more efficacious using similar chemicals as are used in a traditional footbath and still be cheaper to operate on a cost per cow basis because of this efficiency. The hoof treatment fluid can contain one or more active ingredient such as antimicrobial agents, oxidizers, surfactants, viscosity modifiers, hydrotropes, emulsifiers, and solvents, and combinations thereof. The hoof treatment fluid can contain, but is not limited to, active ingredients from the group including hydrogen peroxide, hypochlorite, Peracetic acid, fatty acids, lactic acid, quats, benzalkonium chloride, triclosan, triclocarban, chloramines, ozone, biguanide, hexachlorophene, copper sulfate, zinc sulfate, formaldehyde, glutaraldehyde, organic acids, antibiotics, fungicides, chlorine dioxide, iodine, alcohol, essential oils, short chain carboxylic acids, silver, bronopol, niacin, parabens, benzoic acid, sodium benzoate, lactic acid, acetic acid, propionic acid, ozone, sodium bisulfate, sodium metabisulfate, phenol, phenolic compounds, and combinations thereof. In one embodiment, an active hoof treatment chemical can made in situ by combining two or more constituents in separate product streams prior to flowing from the sprayer. For example, a solution of sodium chlorite may be combined with a solution of an acid to produce chlorine dioxide prior to being sprayed. In a second embodiment, an active hoof treatment chemical can be made more active, for example by increasing or decreasing the pH of the hoof treatment fluid at the time of spraying because the lower pH active is labile and cannot be stored for more than a short time.

Inerts and excipients can also be incorporated into the hoof treatment fluid. These include materials from the group comprised of surfactants, solvents, water, hydrotropes, salts, acids, chelators, emulsifiers, opacifier, pH modifiers, thickeners, dyes, preservatives, and combinations thereof.

In a preferred embodiment of the present invention, the hoof treatment fluid is low foaming. A low foaming fluid allows for the hoof treatment fluid that does not strike the hoof to be collected in recycle compartment in a pumpable form whereby the unused portion of the fluid can be pumped back to the reservoir. A low foaming hoof treatment fluid is a fluid that either generates no or very little foam when sprayed through spray nozzles 3 and collected in the recycle compartment, or generates foam that dissipates quickly into a pumpable fluid. In one embodiment, none of the ingredients in the hoof treatment fluid cause foaming. In another embodiment, when one or more ingredients in the hoof treatment fluid causes foaming a defoamer ingredient can be incorporated into the hoof treatment fluid to reduce or eliminate the foam.

In another embodiment of the device, a sprayer design that limits foaming can be used or a defoaming apparatus can be placed in the recycle compartment 2 which can effectively reduce or eliminate any foaming that occurs. Another means to minimize foaming is to feed a defoaming ingredient into the recycle compartment 2 that causes most of the foam to dissipate. Another means to accomplish this is to incorporate a mechanical system that breaks the foam, such as a heated coil system.

In another embodiment, a multiple part hoof treatment fluid is delivered to the spray nozzles 3 by mixing two or more chemical components together on site to make the hoof treatment fluid. This mixing can occur in a separate operation prior to filling the reservoir.

One advantage of the present invention is that it recycles most of the excess hoof treatment fluid that does not strike the animal hoof. This makes the system very economical because waste is minimized. Because wasted hoof treatment fluid is minimized in the present invention, a more concentrated fluid may be used compared to the concentration of the actives in a footbath. This allows for a more effective treatment regimen. The present invention is less harmful to the environment than traditional footbaths because less chemical ends up in the manure stream that eventually goes onto farmland.

1. A device to apply a hoof treatment fluid to animal hooves, the device comprising:
a reservoir to contain a hoof treatment fluid;
a sensor to detect the presence of an animal;
a sprayer directed toward an anticipated animal hoof location and in communication with the reservoir;
a recycle compartment positioned to receive hoof treatment fluid from the sprayer that does not strike the hoof; and
a return system to return the received hoof treatment fluid in the recycle compartment to the reservoir.

2. The device of claim 1, wherein the sprayer includes a plurality of spray nozzles directed toward the recycle compartment.

3. The device of claim 1, and further comprising a spray nozzle for wash fluid directed toward a walking surface for animals between the sprayer and the recycle compartment.

4. The device of claim 1, wherein the sensor detects an animal in proximity to the sprayer.

5. The device of claim 1, and further comprising: an automated controller that receives a signal from the sensor, and the automated controller controls the spray of treatment fluid in response to the signal.

6. A method for applying a hoof treatment fluid to animal hooves, the method comprising the steps of:
sensing the presence of an animal using a sensor;
spraying hoof treatment fluid toward an animal hoof location;
collecting a portion of the hoof treatment fluid that does not come in contact with the hoof;
recycling the hoof treatment fluid that does not come in contact with the hoof; and
respraying the recycled hoof treatment fluid toward an animal hoof.

7. The method of claim 6, wherein the step of spraying a hoof treatment fluid comprises the step of spraying hoof treatment fluid through a plurality of spray nozzles.

8. The method of claim 6, and further comprising the step of: spraying a wash fluid between a sprayer compartment and a recycle compartment.

9. The method of claim 6, and further comprising the step of: sensing an animal hoof in proximity of the spray nozzle.

10. The method of claim 6, and further comprising the steps of: signaling a controller with a sensor signal; and controlling a hoof treatment solution pump based at least in part on the sensor signal.

11. A device to treat animal hooves, the device comprising:
a hoof treatment chemical reservoir;
an animal sensor;
a transfer pump in fluid communication with the reservoir;
a recycle compartment;
a plurality of spray nozzles in fluid communication with the transfer pump and directed toward the recycle compartment; and
a recirculation pump in fluid communication with both the recycle compartment and the reservoir.

12. The device of claim 11, wherein the spray nozzles are directed above an animal walking surface.

13. The device of claim 11, wherein the device has a wash fluid sprayer directed to an area between the spray nozzles and the recycle compartment.

14. The device of claim 11, wherein the animal sensor signals an automated controller when an animal is in a predetermined proximity of at least one spray nozzle.

15. The device of claim 14, wherein the automated controller is signaled by the animal sensor and the automated controller controls a pump based on the signal.

16. A method for treating animal hooves, the method comprising the steps of:
directing an animal toward a device to treat animal hooves;
treating the animal's hooves with hoof treatment fluids pumped from a reservoir and through a group of spray nozzles; and
recycling overspray from the spray nozzles by collecting overspray in a recycling compartment positioned apart from the spray nozzles and recirculating treatment fluids to the reservoir.

17. The method of claim 16, wherein the step of recycling overspray includes the step of: spraying hoof treatment fluids that do not contact an animal hoof into the recycling compartment.

18. The method of claim 16, and further comprising the step of: dispensing a wash fluid to an animal walking surface between the spray nozzles and the recycling compartment.

19. The method of claim 16, and further comprising the step of: sensing the presence of the animal and then treating at least one animal hoof with treatment fluid.

20. The method of claim 16, and further comprising the step of: controlling hoof treatment spraying and recycling based on a signal from a sensor.
